(19) United States
(12) Patent Application Publication
(10) Pub. No.: US 2026/0046091 A1
(43) Pub. Date: Feb. 12, 2026

(54) Demodulation Reference Signal Bundle for Physical Downlink Control Channel

(71) Applicant: QUALCOMM Incorporated, San Diego, CA (US)

(72) Inventors: Chih-Hao LIU, San Diego, CA (US); Jing SUN, San Diego, CA (US); Morteza SOLTANI, San Diego, CA (US)

(21) Appl. No.: 18/798,563

(22) Filed: Aug. 8, 2024

(51) Int. Cl. H04L 5/00; H04L 25/02; H04W 72/23

(52) U.S. Cl. CPC H04L 5/0053; H04L 25/0224; H04W 72/23

(57) ABSTRACT

Certain aspects of the present disclosure provide techniques for communication of a demodulation reference signal (DMRS) in a DMRS bundle. An example method for wireless communications by an apparatus includes obtaining signaling in a control resource set (CORESET), wherein the signaling includes a plurality of physical downlink control channels (PDCCHs) and a first demodulation reference signal (DMRS) shared among the plurality of PDCCHs; and communicating with a network entity based at least in part on at least one PDCCH of the plurality of PDCCHs and the first DMRS.

### INTRODUCTION

### Field Of The Disclosure

Aspects of the present disclosure relate to wireless communications, and more particularly, to techniques for communication of a demodulation reference signal.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, or the like. Consequently, there exists a need for further improvements in wireless communications systems to overcome the aforementioned technical challenges and others.

### SUMMARY

One aspect provides a method for wireless communications by an apparatus. The method includes obtaining signaling in a control resource set (CORESET), wherein the signaling includes a plurality of physical downlink control channels (PDCCHs) and a first demodulation reference signal (DMRS) shared among the plurality of PDCCHs; and communicating with a network entity based at least in part on at least one PDCCH of the plurality of PDCCHs and the first DMRS.

Another aspect provides a method for wireless communications by an apparatus. The method includes sending signaling, in a CORESET, that includes a plurality of PDCCHs and a first DMRS shared among the plurality of PDCCHs; and communicating with a user equipment based at least in part on at least one PDCCH of the plurality of PDCCHs and the first DMRS.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example scheme for configuring a set of time-frequency resources for communication of control signaling.

FIG. 6 depicts an example Control Resource Set (CORESET) with one or more demodulation reference signal (DMRS) bundles.

FIG. 7 depicts an example process flow for communication of DMRS in one or more DMRS bundles.

FIG. 8 depicts an example method for wireless communications.

FIG. 9 depicts another example method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for communicating a demodulation reference signal (DMRS) for a physical downlink control channel (PDCCH) in a DMRS bundle.

Certain wireless communications systems (e.g., 5G New Radio (NR) and/or any future wireless communications system) may use a PDCCH to transfer downlink control information (DCI) to a user equipment (UE). As an example, the DCI may indicate an uplink or downlink resource allocation for other physical channel(s), such as the physical uplink shared channel (PUSCH) and/or the physical downlink shared channel (PDSCH). In certain cases, the DCI may indicate power control commands for certain uplink transmission(s), such as PUSCH, physical uplink control channel (PUCCH), and/or sounding reference signal (SRS) transmission(s).

A network entity (e.g., a base station) may transmit one or more PDCCHs using resource elements (e.g., time-frequency resources) that belong to a Control Resource Set (CORESET). The CORESET may define a search space (e.g., a set of time-frequency resources) where the UE attempts to decode a PDCCH. The UE may perform blind decoding on signals received in the CORESET, for example, due to the UE not knowing the aggregation level of the PDCCH (e.g., the code rate of the PDCCH), the location of the PDCCH in the CORESET, and/or the payload size of the PDCCH. The PDCCH may be communicated with a DMRS to allow a UE to perform channel estimation of the PDCCH, which may include estimation of the precoding applied at the network entity. For example, as the location and waveform of the DMRS (e.g., transmission time, amplitude, and phase) may be known to the UE, the UE may compare the received signal corresponding to the DMRS to the waveform defined for the DMRS to estimate the phase shift encountered due to signal propagation between the network entity and the UE. The UE may effectively remove the phase shift from the received signals to demodulate the PDCCH.

Technical problems for PDCCH communications may include, for example, effective channel estimation for PDCCH communications. In certain cases, each PDCCH in a COREST may be communicated with a DMRS for channel estimation of the PDCCH. The time-frequency resources (e.g., control channel element(s)) allocated for a PDCCH may be occupied by the payload of the PDCCH (e.g., DCI) and the DMRS. The DMRS may be arranged in certain positions among the time-frequency resources allocated for the PDCCH. As an example, the DMRS may occupy a certain percentage (e.g., 25 %) of the resource elements allocated for the PDCCH. The UE may only have access to a subset of time-frequency resources allocated to a PDCCH to perform channel estimation of a PDCCH. In certain cases, the network entity may apply different precoding to PDCCHs in the CORESET. For example, the precoding applied to the DMRS of one PDCCH communicated in the CORESET may be different from the precoding applied to the DMRS of another PDCCH. The UE may only have a narrow band of frequency resources to perform channel estimation. In some cases, the frequency resources used for the DMRS may encounter interference (or other signal propagation effects), which may distort the DMRS and cause PDCCH decoding failures at a UE. Accordingly, PDCCH decoding failures at the UE may trigger a network entity to retransmit the PDCCH, which may affect the channel usage and/or latency for PDCCH communications.

Certain aspects described herein may overcome the aforementioned technical problem(s), for example, by communicating a DMRS for a PDCCH in one or more DMRS bundles. In certain aspects, one or more DMRS bundles may be defined across the time-frequency resources of a CORESET. As an example, a DMRS bundle may be or include a portion of the CORESET, and any PDCCHs communicated in the DMRS bundle may share the same DMRS (e.g., using the same scrambling sequence and/or precoding to form the waveform of the DMRS). A shared DMRS may refer to a DMRS that uses the same reference signal sequence (e.g., based on the same scrambling seed) and/or precoding for multiple PDCCHs in a DMRS bundle. In certain aspects, multiple DMRS bundles may share the same DMRS, as further described herein. In certain aspects, any time-frequency resources in the DMRS bundle, which do not carry a control signaling payload (e.g., DCI), may be used to communicate the DMRS of a PDCCH. Such a DMRS may be referred to as a wideband DMRS. A wideband DMRS may be or include a DMRS that occupies a certain subset of time-frequency resources allocated to at least one PDCCH as well as one or more other time-frequency resources in the DMRS bundle. Thus, the shared or wideband DMRS within a DMRS bundle may provide frequency diversity for a UE to perform channel estimation of a PDCCH across a wider band of frequency resources within the CORESET.

Certain techniques for communication of a DMRS for a PDCCH in a DMRS bundle described herein may provide various beneficial technical effects and/or advantages. The techniques for communication of a DMRS for a PDCCH in a DMRS bundle may enable improved wireless communications performance, such as reduced latencies and/or increased reliability for control signaling (e.g., DCI). The reduced latencies and/or increased reliability (e.g., in terms of a decoding success rate) may be attributable to the frequency diversity enabled by the increased bandwidth used for the DMRS of a PDCCH, for example, through a shared and/or wideband DMRS. In certain cases, the increased bandwidth used for the DMRS may provide mitigation against frequency dependent interference or other signal propagation effects encountered in the CORESET. For example, suppose interference is distorting the DMRS in a portion of the DMRS bundle, such as a portion of the frequency resources allocated to the PDCCH. As the DMRS may also be communicated in another portion of the DMRS bundle, the increased bandwidth used for the DMRS may allow the UE to perform channel estimation using the DMRS obtained in the other portion of the DMRS bundle, for example, without any subsequent transmissions of the PDCCH.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

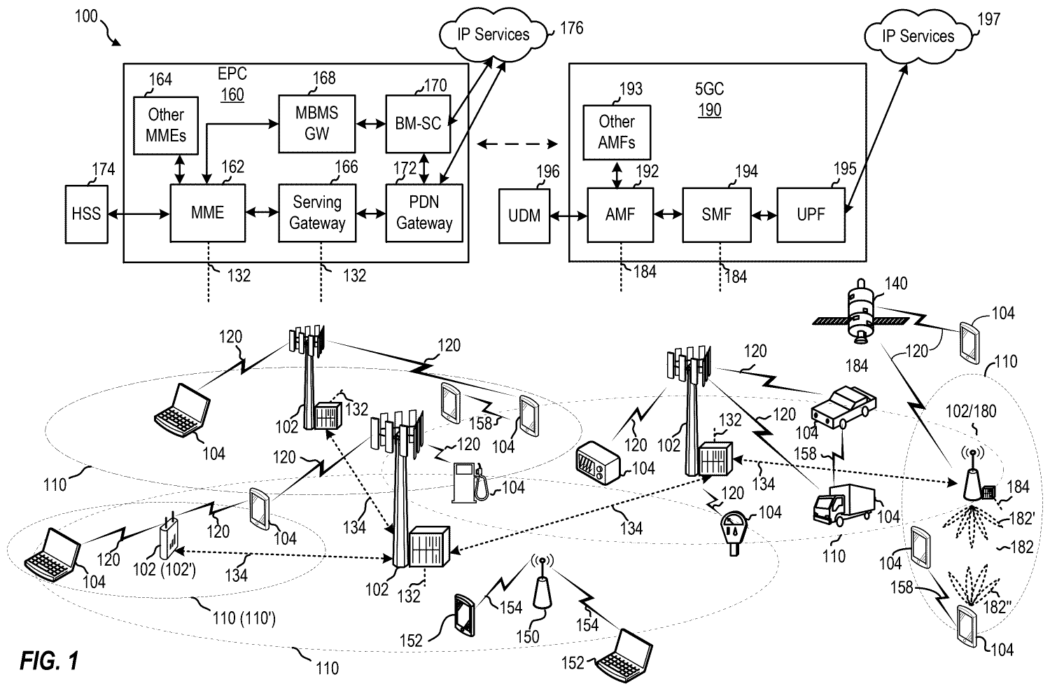

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

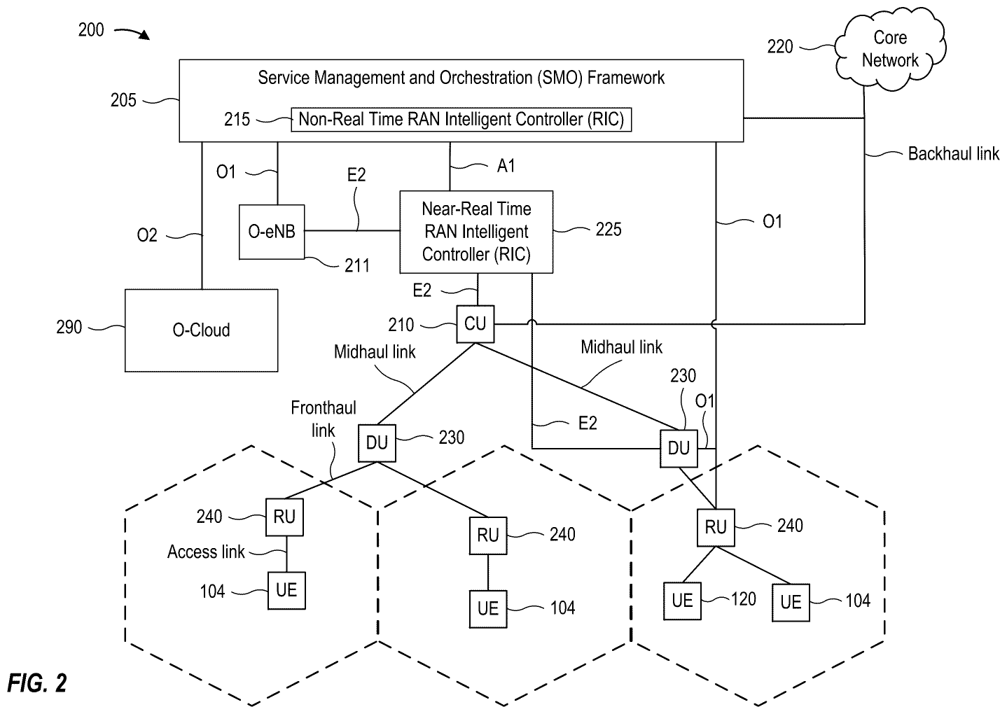

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182″. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182″. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit - User Plane (CU-UP)), control plane functionality (e.g., Central Unit - Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

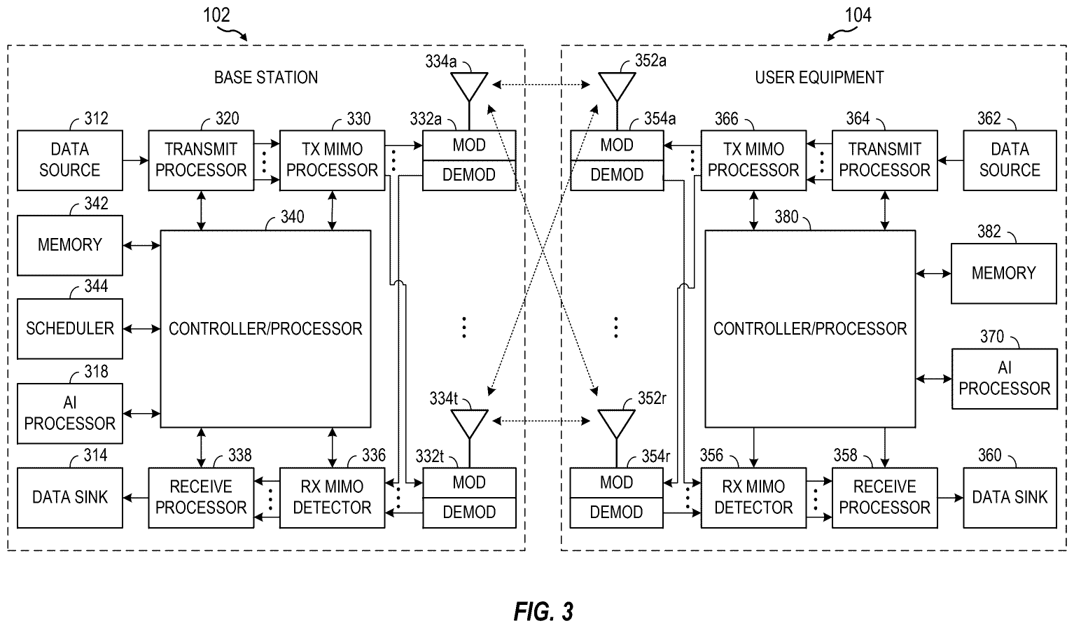

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

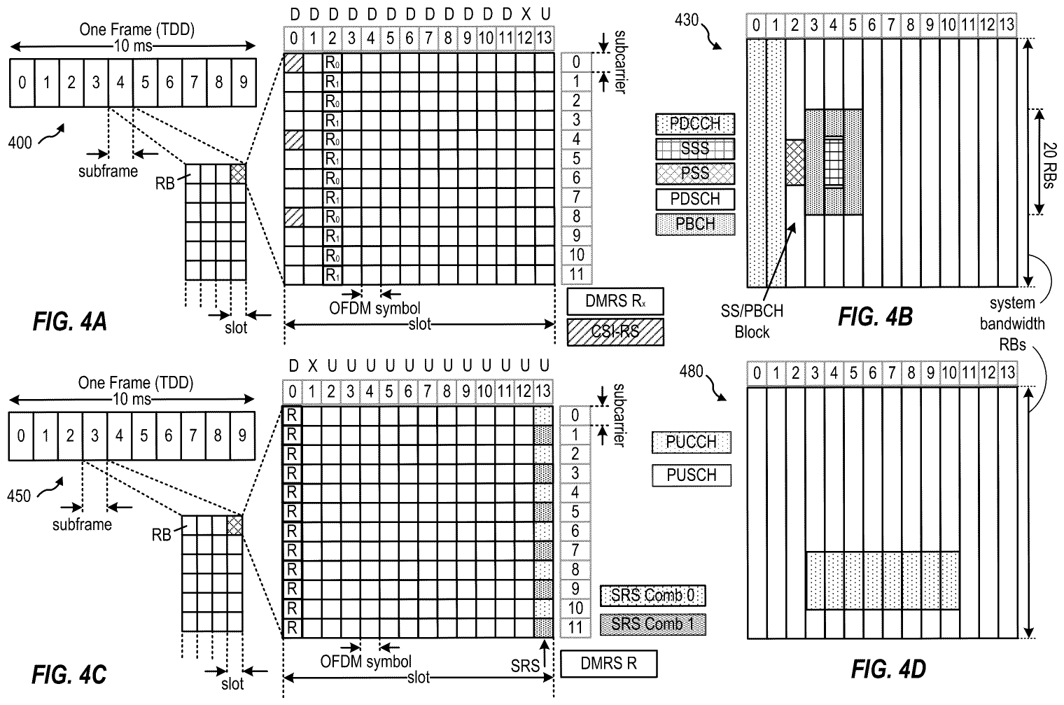

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for both DL and UL. Wireless communications frame structures may also be time division duplex (TDD), in which, for a particular set of subcarriers, subframes within the set of subcarriers are dedicated for either DL or UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ×15} kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example PDCCH Communications

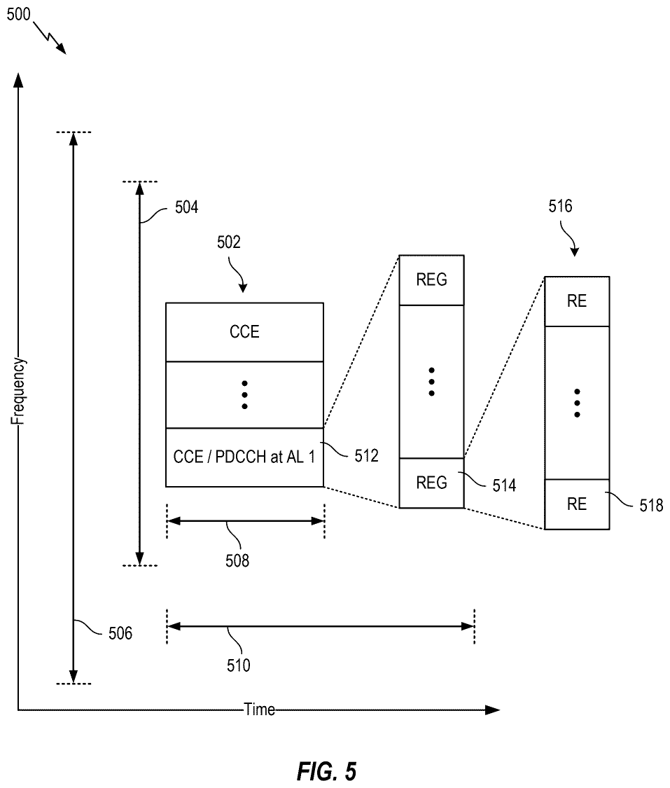

FIG. 5 depicts an example scheme 500 for configuring time-frequency resources for communication of one or more PDCCHs. In certain aspects, a UE may be configured with a control resource set (CORESET) 502, which may occupy a portion of a bandwidth part (BWP) 504 of a carrier 506 in the frequency domain. The bandwidth part 504 may be a contiguous frequency range (e.g., resource blocks) of a channel bandwidth of the carrier 506. The carrier 506 may be a frequency range of an operating band specified for wireless communications, such as an operating band of FR1 and/or FR2. The CORESET 502 may enable flexible configuration or reconfiguration of time-frequency resources for PDCCH communications.

In the time domain, the CORESET 502 may occupy a set of symbols 508 of a slot 510 (such as the first symbol, the first two symbols, or the first three symbols). In the frequency domain, the CORESET 502 may occupy a set of resource blocks (RBs) across the bandwidth part 504. As an example, the set of resource blocks that form the CORESET 502 may be indicated via a bit string, where each bit of the bit string may represent a set of contiguous resource blocks (e.g., 6 resource blocks) in the bandwidth part 502. A specific set of contiguous resource blocks may be included in the CORESET 502 if the corresponding bit of the bit string is set to a particular value (e.g., a value of ‘1’).

The CORESET 502 may include one or more control channel elements (CCES) 512. Each CCE 512 may be formed from a certain number of resource element groups (REGs) 514, such as a total of six REGs. As an example, a REG 514 may occupy a single resource block 516 (e.g., multiple REs 518) in the frequency domain and a single symbol in the time domain. The total number of CCEs 512 used to communicate a PDCCH may be referred to as an aggregation level (AL). Various ALs may be used, such as 1, 2, 4, 8, 16, and/or the like. As an example, at an AL of 1, a single CCE 512 may be used to communicate a PDCCH. At an AL of 2, two CCEs 512 may be used to communicate a PDCCH, for example, with greater redundancy than the redundancy used for the AL of 1, and so on for the other ALs (e.g., 4, 8, and 16). Thus, the AL may also correspond to the code rate (e.g., the level of redundancy information included in the payload of a PDCCH) used to encode the PDCCH. The AL may accommodate the PDCCH and the DMRS for the PDCCH. For example, the DMRS may occupy a portion of the resource elements used by the PDCCH, such as 25 % of the resource elements. The resource elements for the DMRS may be located in certain positions across the AL of the PDCCH.

A search space may include all possible locations (e.g., in time and/or frequency) where a PDCCH may be located. A CORESET may include one or more search spaces, such as a UE-specific search space, a group-common search space, and/or a common search space. A search space may indicate a set of CCEs where a UE may perform blind decoding to find a PDCCH that carries control information (e.g., DCI) for the UE. The possible locations for a PDCCH may depend on whether the PDCCH is a UE-specific PDCCH (e.g., for a single UE) or a group-common PDCCH (e.g., for multiple UEs), an aggregation level being used, and/or the like. A possible location (e.g., in time and/or frequency) for a PDCCH may be referred to as a PDCCH candidate, and the set of all possible PDCCH locations may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space.

A CORESET may be non-interleaved or interleaved. A non-interleaved CORESET may have a CCE-to-REG mapping such that all CCEs are mapped to consecutive REG bundles (e.g., in the frequency domain) of the CORESET. For example, a CCE may be formed from a bundle of 6 consecutively numbered REGs, and the REG numbering may increase with time and then increase with frequency. An interleaved CORESET may have CCE-to-REG mapping such that a CCE may be formed from one or more REG bundles (e.g., a set of REGs), which may be interleaved in the frequency domain. In certain aspects, the CORESET may rotate the CCE numbering based on an interleaver depth.

Note that FIG. 3 is provided as an example to facilitate an understanding of PDCCH communications. Other examples may differ from what is described with respect to FIG. 3.

### Aspects Related to a DMRS Bundle for PDCCH Communications

Aspects of the present disclosure provide techniques for communicating a DMRS for a PDCCH in one or more DMRS bundles. Communication of the DMRS for the PDCCH in one or more DMRS bundles may enable reduced latencies and/or increased reliability of PDCCH communications. For example, the DMRS bunde(s) may provide enhanced frequency diversity for PDCCH communications, which may provide mitigation for frequency dependent interference.

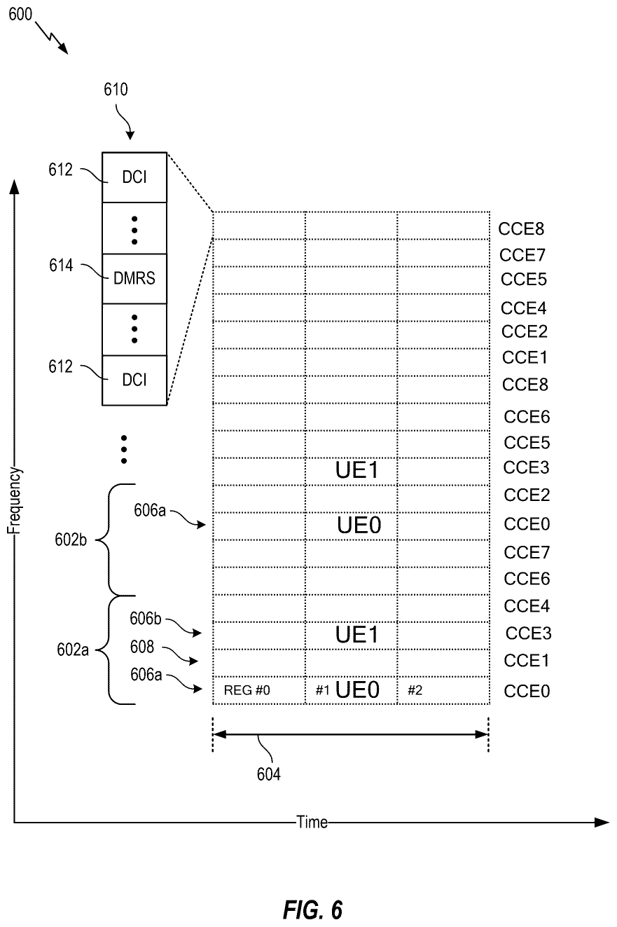

FIG. 6 depicts an example CORESET 600 with one or more DMRS bundles 602a, 602b. A UE may be configured with a CORESET (such as the CORESET 600) having any number of DMRS bundles arranged across the CORESET. The UE may be preconfigured with a CORESET having DMRS bundle(s) or obtain a configuration or reconfiguration for such a CORESET via signaling, such as RRC signaling, MAC signaling, system information, DCI, and/or the like.

As discussed with respect to FIG. 5, the set of time-frequency resources 610 allocated for a PDCCH may accommodate a DCI payload 612 and a DMRS 614 associated with the PDCCH. The DMRS 614 may be arranged in a portion of the set of time-frequency resources 610, such as fixed or predefined position(s) across the set of time-frequency resources 610. As an example, the DMRS 614 may be interleaved in the frequency domain at the predefined position(s) among the set of time-frequency resources 610.

The CORESET 600 may be an example of the CORESET 502 of FIG. 5. In this example, the CORESET 600 may be interleaved with two REG bundles per CCE and an interleaver depth of 3. In the time domain, the CORESET 600 may have a duration 604, for example, in terms of a set of contiguous symbols (such as, 3 symbols as depicted). Note that aspects of the present disclosure may apply to DMRS bundle(s) 602a, 602b being arranged across a non-interleaved CORESET.

Each of the DMRS bundle(s) 602a, 602b may be defined as a set of communication resources (e.g., time-frequency resource(s)) within the CORESET 600. In certain aspects, each of the DMRS bundle(s) 602a, 602b may include at least a portion of the CORESET 600. In certain cases, a DMRS bundle (e.g., 602a) may be or include a range of frequency resources, for example, between a start frequency resource and an end frequency resource, and the duration the DMRS bundle may match the duration of the CORESET. For example, the first DMRS bundle 602a may include a plurality of CCEs or one or more portions thereof (e.g., REG bundle(s)); and the second DMRS bundle 602b may include another plurality of CCEs or one or more portions thereof. In certain cases, each of the DMRS bundles 602a, 602b may be or include a different set of resource blocks within the CORESET. Each of the DMRS bundles 602a, 602b may be non-overlapping with any other DMRS bundle of the CORESET in the frequency domain. With respect to an interleaved CORESET, each of the DMRS bundles 602a, 602b may include one or more REG bundles. For example, the first DMRS bundle 602a may include a REG bundle for each of the CCE0, CCE1, CCE3, and CCE4.

In certain aspects, any PDCCHs communicated in a DMRS bundle 602a, 602b may have a shared or common DMRS. The shared or common DMRS may mean that the PDCCHs communicated in a DMRS bundle may use the same precoding (e.g., digital beamforming) and/or sequence generator (e.g., a pseudo-random sequence generator) that forms the waveform of the DMRS. As an example, a first PDCCH 606a and a second PDCCH 606b (or portion(s) thereof, such as REG bundle(s) of the corresponding CCE(s)) may be communicated in the first DMRS bundle 602a. In certain cases, the first PDCCH 606a and/or the second PDCCH 606b may be a common PDCCH, a group-common PDCCH, and/or UE-specific PDCCH. For example, the DCI payload of the first PDCCH 606a and/or the second PDCCH 606b may be scrambled using a common scrambling identity (e.g., a cell identity), a group-common scrambling identity, and/or a UE-specific scrambling identity. The shared DMRS arranged in a portion of the time-frequency resources allocated for the first PDCCH 606a and the second PDCCH 606b may be communicated using the same precoding and/or the sequence that forms the waveform of the DMRS. Thus, the shared DMRS may allow the UE to use the DMRS communicated in the time-frequency resources of multiple PDCCHs to perform channel estimation. Such frequency diversity for the DMRS may enable reduced latencies and/or increased reliability of PDCCH communications.

The DMRS may be formed using a pseudo-random sequence generator using a scrambling seed (e.g., initialization seed) for a DMRS bundle. The scrambling seed may be or include one or more of a cell identity (e.g., a physical layer cell identity (PCI)) or a scrambling identity (e.g., the pdcch-DMRS-ScramblingID of a CORESET configuration). The cell identity may allow all of the UEs (within the coverage area of a cell) to share same scrambling seed. The scrambling identity may allow a specific group of UEs (or a specific UE) to be configured with the same scrambling seed. Each of the DMRS bundles 602a, 602b may have a particular common scrambling seed, which may be the cell identity and/or the scrambling identity. For example, the first DMRS bundle 602a may use the scrambling identity for a group-common DMRS or UE-specific DMRS, and the second DMRS bundle may use the cell identity for a common DMRS. A common scrambling seed may mean that the scrambling seed is accessible to or provided to a plurality of UEs. A group-common scrambling seed may mean that the scrambling seed is provided to a particular group of UEs. A UE-specific scrambling seed may mean that the scrambling seed is provided to a single UE.

In certain cases, precoding cycling may be performed at the DMRS bundle level. Each of the DMRS bundles may apply the same or different precoding for PDCCH communications. For example, a first DMRS may be communicated in the first DMRS bundle using a first precoding (e.g., that forms a first angle of departure), and a second DMRS may be communicated in the second DMRS bundle using a second precoding different from the first precoding (e.g., that forms a second angle of departure).

In certain aspects, the DMRS of a DMRS bundle may be or include a wideband DMRS. The wideband DMRS may mean that the DMRS may be communicated in the portion of time-frequency resources allocated to a PDCCH and other time-frequency resource(s) of the DMRS bundle (which may or not be allocated to another PDCCH). The wideband DMRS may be formed using the same precoding and/or using the same reference signal sequence generator (e.g., pseudo-random sequence generator). Thus, the wideband DMRS may allow the UE to use certain time-frequency resource(s) in addition to the portion of the time-frequency resource(s) allocated to the PDCCH to perform channel estimation. Such frequency diversity for the DMRS may enable reduced latencies and/or increased reliability of PDCCH communications.

With respect to an interleaved CORESET, when a PDCCH is communicated in REG bundles located in multiple DMRS bundles, a shared DMRS may be used for such DMRS bundles. As an example, the REG bundles for CCE0 may be used to communicate the first PDCCH. Due to the REG bundles being located in the first DMRS bundle and the second DMRS bundle, the first DMRS bundle and the second DMRS bundle may use a shared or wideband DMRS, which may be formed using the same precoding and/or same reference signal sequence generator.

### Example Signaling Related to a DMRS Bundle for PDCCH Communications

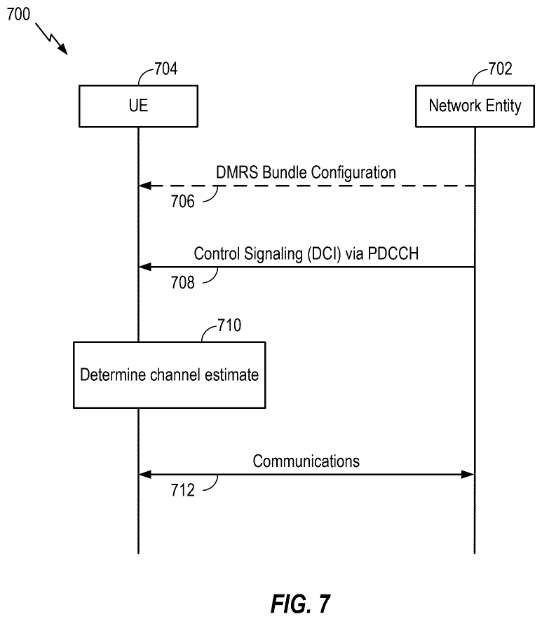

FIG. 7 depicts a process flow 700 for communication of a DMRS in one or more DMRS bundles in a network between a network entity 702 and a user equipment (UE) 704. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

At 706, the UE 704 optionally obtains, from the network entity 702, one or more configurations, for example, including a DMRS bundle configuration. In certain cases, the one or more configurations may include a CORESET configuration, which may indicate or include the DMRS bundle configuration. The DMRS bundle configuration may indicate that one or more DMRS bundles are arranged across a CORESET, for example, as described herein with respect to FIG. 6. In certain cases, the DMRS bundle configuration may indicate the specific time-frequency location(s) of the one or more DMRS bundles across the CORESET, for example, in terms of a start frequency resource and an end frequency resource per DMRS bundle. The DMRS bundle configuration may indicate, for each of the DMRS bundle(s), the respective time-frequency resource(s) included in the respective DMRS bundle. The DMRS bundle configuration may further indicate that each of the DMRS bundles may have a respective shared or wideband DMRS. In certain cases, the DMRS bundle configuration may indicate a scrambling seed (e.g., a common scrambling seed, group-common scrambling seed, and/or a UE-specific scrambling seed) for generation or determination of the waveform of the DMRS of at least one DMRS bundle. In certain cases, the DMRS bundle configuration may be communicated via system information, RRC signaling, MAC signaling, DCI, and/or the like. In certain cases, the UE 704 may be preconfigured with the DMRS bundle configuration.

At 708, the UE 704 obtains, from the network entity 702, signaling in the CORESET, for example, having the one or more DMRS bundles according to the DMRS bundle configuration. In certain cases, the signaling may include multiple PDCCHs and a shared DMRS arranged in at least one DMRS bundle according to the DMRS bundle configuration. In certain cases, the signaling may include at least one PDCCH and a wideband DMRS arranged in at least one DMRS bundle according to the DMRS bundle. The PDCCH(s) may carry control signaling, such as Layer-1 signaling and/or DCI.

At 710, the UE 704 determines a channel estimate for the PDCCH based at least in part on the DMRS. The UE 704 may determine the channel estimate based at least in part on one or more measurements of the DMRS. For example, the UE 704 may compare the DMRS obtained at 708 to the known sequence or waveform of the DMRS (e.g., based on the scrambling seed) to determine the channel estimate (e.g., phase shift, amplitude attenuation, and/or the like encountered due to signal propagation effects between the UE 704 and the network entity 702). The frequency diversity provided by the shared or wideband DMRS of a DMRS bundle may enable reduced latencies and/or increased reliability of PDCCH communications.

At 712, the UE 704 may communicate with the network entity 702 based at least in part on at least one PDCCH and the DMRS in the signaling. As an example, the UE 704 may adjust the signaling obtained at 708 (e.g., remove the phase shift) to demodulate and/or decode the signaling. In certain cases, the PDCCH may carry DCI that indicates a resource allocation (e.g., an uplink resource allocation and/or a downlink resource allocation) for communications between the UE 704 and the network entity 702. As an example, the UE 704 may send an uplink transmission to the network entity 702 according to the uplink resource allocation. As another example, the UE 704 may obtain a downlink transmission from the network entity 702 according to the downlink resource allocation. In certain cases, the DCI may indicate or include any other suitable information, such as transmit power control commands or the like.

Note that the process flow illustrated in FIG. 7 is described herein to facilitate an understanding of communication of a DMRS in a DMRS bundle, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Operations Related to a DMRS Bundle for PDCCH Communications

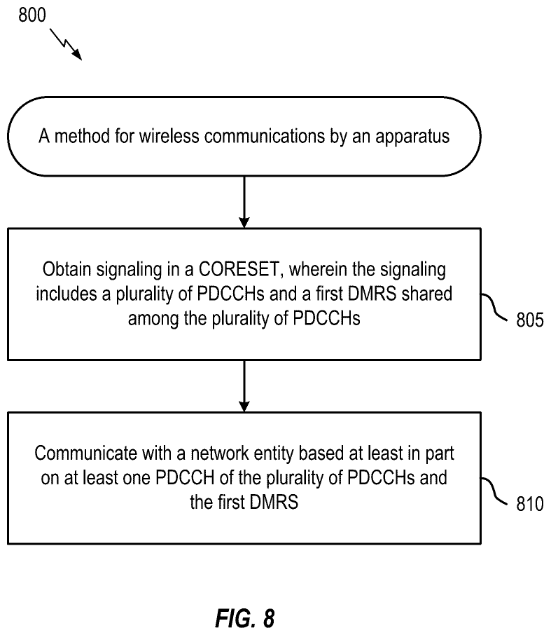

FIG. 8 shows a method 800 for wireless communications by an apparatus, such as UE 104 of FIGS. 1 and 3.

Method 800 begins at block 805 with obtaining signaling in a CORESET, wherein the signaling includes a plurality of PDCCHs and a first DMRS shared among the plurality of PDCCHs, for example, as described herein with respect to FIGS. 6 and 7. The first DMRS may provide frequency diversity for communication of the DMRS, which may enable reduced latencies and/or increased reliability of PDCCH communications.

Method 800 then proceeds to block 810 with communicating with a network entity based at least in part on at least one PDCCH of the plurality of PDCCHs and the first DMRS, for example, as described herein with respect to FIG. 7.

In one aspect, block 810 includes: determining a channel estimate, for the at least one PDCCH, based at least in part on one or more measurements of the first DMRS; and decoding the least one PDCCH based at least in part on the channel estimate.

In one aspect, the plurality of PDCCHs are arranged in at least a first portion of a first set of communication resources of the CORESET (such as a DMRS bundle); and the first DMRS is arranged in at least a second portion of the first set of communication resources. In one aspect, the first DMRS is interleaved, in the second portion, across the first set of communication resources. In one aspect, the first DMRS is further arranged in a second set of communication resources of the CORESET. In one aspect, the CORESET comprises a DMRS bundle comprising the first DMRS and the plurality of PDCCHs. In one aspect, the DMRS bundle comprises a portion of the CORESET comprising a plurality of control channel elements.

In one aspect, method 800 further includes obtaining one or more configurations that indicate one or more DMRS bundles are arranged across the CORESET, wherein each DMRS bundle of the one or more DMRS bundles has a respective DMRS shared at least among multiple PDCCHs communicated in the respective DMRS bundle; and block 805 includes obtaining the first DMRS based at least in part on the one or more configurations.

In one aspect, the one or more DMRS bundles comprise a first DMRS bundle and a second DMRS bundle; the at least one PDCCH is interleaved across the first DMRS bundle and the second DMRS bundle; and the first DMRS is shared for the first DMRS bundle and the second DMRS bundle.

In one aspect, the one or more configurations further indicate a common seed for determination of a sequence of the first DMRS. In one aspect, the common seed includes one or more of a cell identity or a scrambling identity.

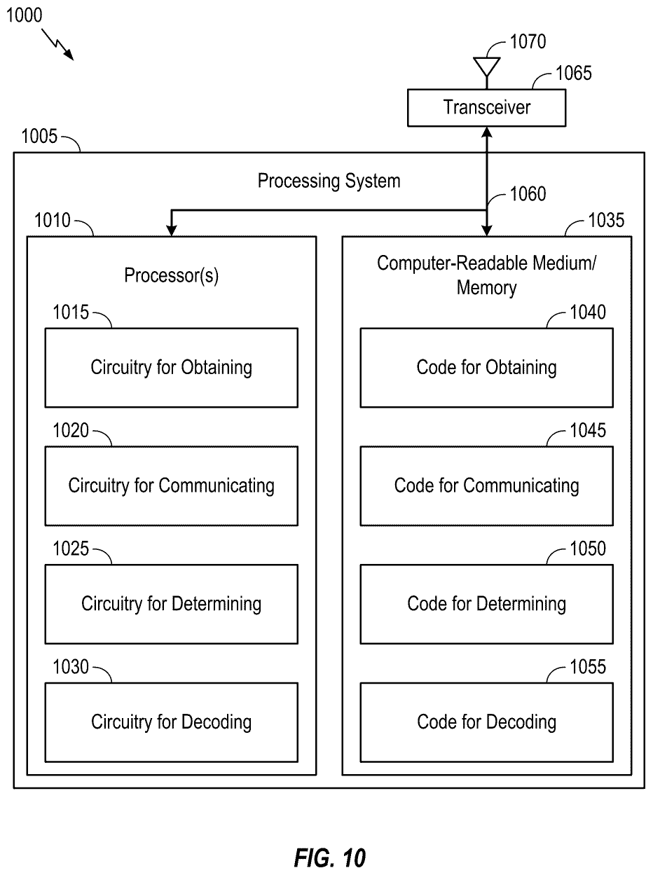

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

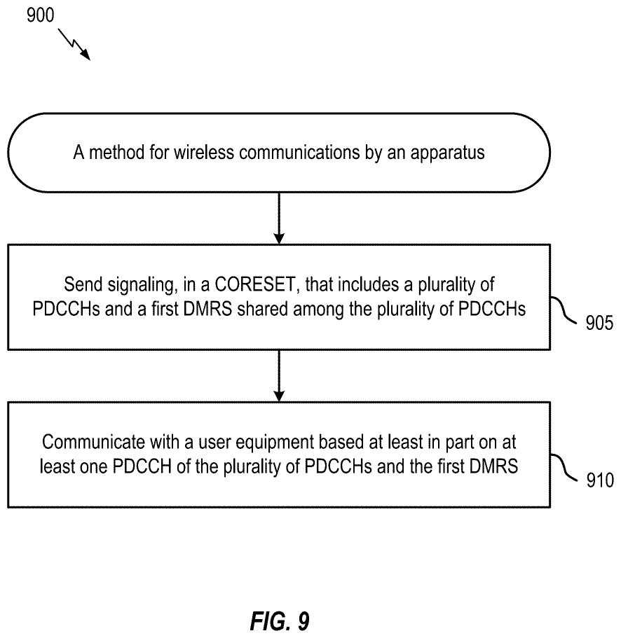

FIG. 9 shows a method 900 for wireless communications by an apparatus, such as BS 102 of FIGS. 1 and 3, or a disaggregated base station as discussed with respect to FIG. 2.

Method 900 begins at block 905 with sending signaling, in a CORESET, that includes a plurality of PDCCHs and a first DMRS shared among the plurality of PDCCHs, for example, as described herein with respect to FIGS. 6 and 7.

Method 900 then proceeds to block 910 with communicating with a user equipment based at least in part on at least one PDCCH of the plurality of PDCCHs and the first DMRS, for example, as described herein with respect to FIG. 7.

In one aspect, the plurality of PDCCHs are arranged in at least a first portion of a first set of communication resources of the CORESET; and the first DMRS is arranged in at least a second portion of the first set of communication resources. In one aspect, the first DMRS is interleaved, in the second portion, across the first set of communication resources. In one aspect, the first DMRS is further arranged in a second set of communication resources of the CORESET. In one aspect, the CORESET comprises a DMRS bundle comprising the first DMRS and the plurality of PDCCHs. In one aspect, the DMRS bundle comprises a portion of the CORESET comprising a plurality of control channel elements.

In certain aspects, method 900 further includes sending one or more configurations that indicate one or more DMRS bundles are arranged across the CORESET, wherein each DMRS bundle of the one or more DMRS bundles has a respective DMRS shared at least among multiple PDCCHs communicated in the respective DMRS bundle; and block 905 includes sending the first DMRS based at least in part on the one or more configurations.

In one aspect, the one or more DMRS bundles comprise a first DMRS bundle and a second DMRS bundle; the at least one PDCCH is interleaved across the first DMRS bundle and the second DMRS bundle; and the first DMRS is shared for the first DMRS bundle and the second DMRS bundle.

In one aspect, the one or more configurations further indicate a common seed for determination of a sequence of the first DMRS. In one aspect, the common seed includes one or more of a cell identity or a scrambling identity.

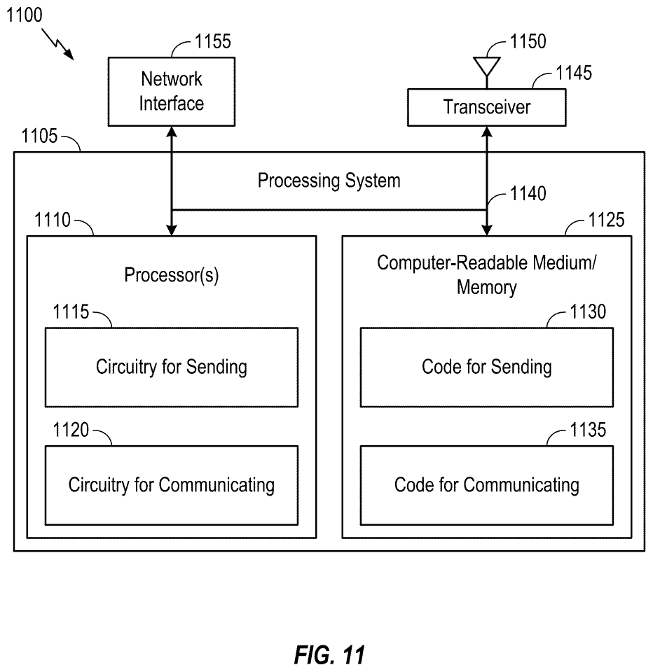

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to a transceiver 1065 (e.g., a transmitter and/or a receiver). The transceiver 1065 is configured to transmit and receive signals for the communications device 1000 via an antenna 1070, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1035 via a bus 1060. In certain aspects, the computer-readable medium/memory 1035 is configured to store instructions (e.g., computer-executable code), including code 1040-1055, that when executed by the one or more processors 1010, enable and cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1035 stores code for obtaining 1040, code for communicating 1045, code for determining 1050, and code for decoding 1055. Processing of the code 1040-1055 may enable and cause the communications device 1000 to perform the method 800 described with respect to FIG. 8, or any aspect related to it.

The one or more processors 1010 include circuitry configured to implement (e.g., execute) the code (e.g., executable instructions) stored in the computer-readable medium/memory 1035, including circuitry for obtaining 1015, circuitry for communicating 1020, circuitry for determining 1025, and circuitry for decoding 1030. Processing with circuitry 1015-1030 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1065 and/or antenna 1070 of the communications device 1000 in FIG. 10, and/or one or more processors 1010 of the communications device 1000 in FIG. 10. Means for communicating, receiving or obtaining may include the transceivers 354, antenna(s) 352, receive processor 358, AI processor 370, and/or controller/processor 380 of the UE 104 illustrated in FIG. 3, transceiver 1065 and/or antenna 1070 of the communications device 1000 in FIG. 10, and/or one or more processors 1010 of the communications device 1000 in FIG. 10. For example, means for determining and/or means for decoding of the method 800 described with respect to FIG. 8, or any aspect related to it, may include AI processor 370, and/or controller/processor 380 of the UE 104 illustrated in FIG. 3, and/or one or more processors 1010 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to a transceiver 1145 (e.g., a transmitter and/or a receiver) and/or a network interface 1155. The transceiver 1145 is configured to transmit and receive signals for the communications device 1100 via an antenna 1150, such as the various signals as described herein. The network interface 1155 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code), including code 1130 and 1135, that when executed by the one or more processors 1110, enable and cause the one or more processors 1110 to perform the method 900 described with respect to FIG. 9, or any aspect related to it, including any operations described in relation to FIG. 9. Note that reference to a processor of communications device 1100 performing a function may include one or more processors of communications device 1100 performing that function, such as in a distributed fashion.

In the depicted example, the computer-readable medium/memory 1125 stores code for sending 1130 and code for communicating 1135. Processing of the code 1130 and 1135 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1125, including circuitry for sending 1115 and circuitry for communicating 1120. Processing with circuitry 1115 and 1120 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1145, antenna 1150, and/or network interface 1155 of the communications device 1100 in FIG. 11, and/or one or more processors 1110 of the communications device 1100 in FIG. 11. Means for communicating, receiving or obtaining may include the transceivers 332, antenna(s) 334, receive processor 338, AI processor 318, and/or controller/processor 340 of the BS 102 illustrated in FIG. 3, transceiver 1145, antenna 1150, and/or network interface 1155 of the communications device 1100 in FIG. 11, and/or one or more processors 1110 of the communications device 1100 in FIG. 11.

### Example Clauses

Implementation examples are described in the following numbered clauses:

Clause 1: A method for wireless communications by an apparatus comprising: obtaining signaling in a CORESET, wherein the signaling includes a plurality of PDCCHs and a first DMRS shared among the plurality of PDCCHs; and communicating with a network entity based at least in part on at least one PDCCH of the plurality of PDCCHs and the first DMRS.

Clause 2: The method of Clause 1, wherein communicating with the network entity comprises: determining a channel estimate, for the at least one PDCCH, based at least in part on one or more measurements of the first DMRS; and decoding the least one PDCCH based at least in part on the channel estimate.

Clause 3: The method of any one of Clauses 1-2, wherein: the plurality of PDCCHs are arranged in at least a first portion of a first set of communication resources of the CORESET; and the first DMRS is arranged in at least a second portion of the first set of communication resources.

Clause 4: The method of Clause 3, wherein the first DMRS is interleaved, in the second portion, across the first set of communication resources.

Clause 5: The method of Clause 3 or 4, wherein the first DMRS is further arranged in a second set of communication resources of the CORESET.

Clause 6: The method of any one of Clauses 1-5, wherein the CORESET comprises a DMRS bundle comprising the first DMRS and the plurality of PDCCHs.

Clause 7: The method of Clause 6, wherein the DMRS bundle comprises a portion of the CORESET comprising a plurality of control channel elements.

Clause 8: The method of any one of Clauses 1-7, further comprising obtaining one or more configurations that indicate one or more DMRS bundles are arranged across the CORESET, wherein each DMRS bundle of the one or more DMRS bundles has a respective DMRS shared at least among multiple PDCCHs communicated in the respective DMRS bundle; and obtaining the signaling comprises obtaining the first DMRS based at least in part on the one or more configurations.

Clause 9: The method of Clause 8, wherein: the one or more DMRS bundles comprise a first DMRS bundle and a second DMRS bundle; the at least one PDCCH is interleaved across the first DMRS bundle and the second DMRS bundle; and the first DMRS is shared for the first DMRS bundle and the second DMRS bundle.

Clause 10: The method of Clause 8 or 9, wherein the one or more configurations further indicate a common seed for determination of a sequence of the first DMRS.

Clause 11: The method of Clause 10, wherein the common seed includes one or more of a cell identity or a scrambling identity.

Clause 12: A method for wireless communications by an apparatus comprising: sending signaling, in a CORESET, that includes a plurality of PDCCHs and a first DMRS shared among the plurality of PDCCHs; and communicating with a user equipment based at least in part on at least one PDCCH of the plurality of PDCCHs and the first DMRS.

Clause 13: The method of Clause 12, wherein: the plurality of PDCCHs are arranged in at least a first portion of a first set of communication resources of the CORESET; and the first DMRS is arranged in at least a second portion of the first set of communication resources.

Clause 14: The method of Clause 13, wherein the first DMRS is interleaved, in the second portion, across the first set of communication resources.

Clause 15: The method of Clause 13 or 14, wherein the first DMRS is further arranged in a second set of communication resources of the CORESET.

Clause 16: The method of any one of Clauses 12-15, wherein the CORESET comprises a DMRS bundle comprising the first DMRS and the plurality of PDCCHs.

Clause 17: The method of Clause 16, wherein the DMRS bundle comprises a portion of the CORESET comprising a plurality of control channel elements.

Clause 18: The method of any one of Clauses 12-17, further comprising sending one or more configurations that indicate one or more DMRS bundles are arranged across the CORESET, wherein each DMRS bundle of the one or more DMRS bundles has a respective DMRS shared at least among multiple PDCCHs communicated in the respective DMRS bundle; and sending the signaling comprises sending the first DMRS based at least in part on the one or more configurations.

Clause 19: The method of Clause 18, wherein: the one or more DMRS bundles comprise a first DMRS bundle and a second DMRS bundle; the at least one PDCCH is interleaved across the first DMRS bundle and the second DMRS bundle; and the first DMRS is shared for the first DMRS bundle and the second DMRS bundle.

Clause 20: The method of Clause 18 or 19, wherein the one or more configurations further indicate a common seed for determination of a sequence of the first DMRS.

Clause 21: The method of Clause 20, wherein the common seed includes one or more of a cell identity or a scrambling identity.

Clause 22: One or more apparatuses, comprising: one or more memories comprising executable instructions; and one or more processors configured to execute the executable instructions and cause the one or more apparatuses to perform a method in accordance with any one of Clauses 1-21.

Clause 23: One or more apparatuses, comprising: one or more memories; and one or more processors, coupled to the one or more memories, configured to cause the one or more apparatuses to perform a method in accordance with any one of Clauses 1-21.

Clause 24: One or more apparatuses, comprising: one or more memories; and one or more processors, coupled to the one or more memories, configured to perform a method in accordance with any one of Clauses 1-21.

Clause 25: One or more apparatuses, comprising means for performing a method in accordance with any one of Clauses 1-21.

Clause 26: One or more non-transitory computer-readable media comprising executable instructions that, when executed by one or more processors of one or more apparatuses, cause the one or more apparatuses to perform a method in accordance with any one of Clauses 1-21.

Clause 27: One or more computer program products embodied on one or more computer-readable storage media comprising code for performing a method in accordance with any one of Clauses 1-21.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining or the like. Also, “determining” may include receiving (e.g., receiving information), accessing (e.g., accessing data in a memory) or the like. Also, “determining”may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more. ” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain signaling in a control resource set (CORESET), wherein the signaling includes a plurality of physical downlink control channels (PDCCHs) and a first demodulation reference signal (DMRS) shared among the plurality of PDCCHs; and
communicate with a network entity based at least in part on at least one PDCCH of the plurality of PDCCHs and the first DMRS.

2. The apparatus of claim 1, wherein to communicate with the network entity, the one or more processors are configured to cause the apparatus to:
determine a channel estimate, for the at least one PDCCH, based at least in part on one or more measurements of the first DMRS; and
decode the least one PDCCH based at least in part on the channel estimate.

3. The apparatus of claim 1, wherein:
the plurality of PDCCHs are arranged in at least a first portion of a first set of communication resources of the CORESET; and
the first DMRS is arranged in at least a second portion of the first set of communication resources.

4. The apparatus of claim 3, wherein the first DMRS is interleaved, in the second portion, across the first set of communication resources.

5. The apparatus of claim 3, wherein the first DMRS is further arranged in a second set of communication resources of the CORESET.

6. The apparatus of claim 1, wherein the CORESET comprises a DMRS bundle comprising the first DMRS and the plurality of PDCCHs.

7. The apparatus of claim 6, wherein the DMRS bundle comprises a portion of the CORESET comprising a plurality of control channel elements.

8. The apparatus of claim 1, wherein:
the one or more processors are configured to cause the apparatus to obtain one or more configurations that indicate one or more DMRS bundles are arranged across the CORESET, wherein each DMRS bundle of the one or more DMRS bundles has a respective DMRS shared at least among multiple PDCCHs communicated in the respective DMRS bundle; and
to obtain the signaling, the one or more processors are configured to cause the apparatus to obtain the first DMRS based at least in part on the one or more configurations.

9. The apparatus of claim 8, wherein:
the one or more DMRS bundles comprise a first DMRS bundle and a second DMRS bundle;
the at least one PDCCH is interleaved across the first DMRS bundle and the second DMRS bundle; and
the first DMRS is shared for the first DMRS bundle and the second DMRS bundle.

10. The apparatus of claim 8, wherein the one or more configurations further indicate a common seed for determination of a sequence of the first DMRS.

11. The apparatus of claim 10, wherein the common seed includes one or more of a cell identity or a scrambling identity.

12. An apparatus configured for wireless communications, comprising:
one or more memories; and
one or more processors coupled to the one or more memories, the one or more processors being configured to cause the apparatus to:
send signaling, in a control resource set (CORESET), that includes a plurality of physical downlink control channels (PDCCHs) and a first demodulation reference signal (DMRS) shared among the plurality of PDCCHs; and
communicate with a user equipment based at least in part on at least one PDCCH of the plurality of PDCCHs and the first DMRS.

13. The apparatus of claim 12, wherein:
the plurality of PDCCHs are arranged in at least a first portion of a first set of communication resources of the CORESET; and
the first DMRS is arranged in at least a second portion of the first set of communication resources.

14. The apparatus of claim 13, wherein the first DMRS is interleaved, in the second portion, across the first set of communication resources.

15. The apparatus of claim 13, wherein the first DMRS is further arranged in a second set of communication resources of the CORESET.

16. The apparatus of claim 12, wherein the CORESET comprises a DMRS bundle comprising the first DMRS and the plurality of PDCCHs.

17. The apparatus of claim 16, wherein the DMRS bundle comprises a portion of the CORESET comprising a plurality of control channel elements.

18. The apparatus of claim 12, wherein:
the one or more processors are configured to cause the apparatus to send one or more configurations that indicate one or more DMRS bundles are arranged across the CORESET, wherein each DMRS bundle of the one or more DMRS bundles has a respective DMRS shared at least among multiple PDCCHs communicated in the respective DMRS bundle; and
to send the signaling, the one or more processors are configured to cause the apparatus to send the first DMRS based at least in part on the one or more configurations.

19. The apparatus of claim 18, wherein:
the one or more DMRS bundles comprise a first DMRS bundle and a second DMRS bundle;
the at least one PDCCH is interleaved across the first DMRS bundle and the second DMRS bundle; and
the first DMRS is shared for the first DMRS bundle and the second DMRS bundle.

20. A method for wireless communications by an apparatus, comprising:
obtaining signaling in a control resource set (CORESET), wherein the signaling includes a plurality of physical downlink control channels (PDCCHs) and a first demodulation reference signal (DMRS) shared among the plurality of PDCCHs; and
communicating with a network entity based at least in part on at least one PDCCH of the plurality of PDCCHs and the first DMRS.
